(19) United States
(12) Patent Application Publication
(10) Pub. No.: US 2025/0124901 A1
(43) Pub. Date: Apr. 17, 2025

(54) Easy Application Harmonica Holder

(71) Applicant: Gregory Smith, Edgewood, MD (US)

(72) Inventor: Gregory Smith, Edgewood, MD (US)

(21) Appl. No.: 18/485,399

(22) Filed: Oct. 12, 2023

(51) Int. Cl. G10G 5/00

(52) U.S. Cl. CPC G10G 5/005

(57) ABSTRACT

Easy Application Harmonica Holder is a 1-piece harmonica holder that keeps the harmonica positioned directly in front of the microphone allowing the musician to play other handheld instruments simultaneously. The difference between this device, the Easy Application Harmonica Holder and prior harmonica holding devices is, it is 1 piece and it does not require you to remove or add any parts or pieces. It mounts directly to the top of the microphone. It keeps the harmonica in place in a groove eliminating the need for springs, brackets or magnets making changing harmonicas much quicker. It is limited to the popular raised-back-edge harmonicas. It is made in a way to mimic cupping a microphone by hand while playing the harmonica.

### FIELD OF INVENTION

This invention is related to musicians who play musical instruments, such as a guitar and harmonica simultaneously, then switch back to using the same microphone for vocals. Harmonica players frequently need to change harmonicas to play in different keys. This one-piece device makes applying and removing the device itself easy and fast by simply lifting it off, using 1 hand and also exchanging the harmonica being used with another, with the use of 1 hand.

### BACKGROUND

Harmonica holders have been around for a long time. Most use Screws, Bolts, Brackets and magnets to mount to a microphone stand. They require 2 hands to apply and remove and are generally cumbersome. Then there is the neck supported harmonica holder used by generations of musicians. Again, cumbersome while using it and requires 2 hands to exchange harmonicas to a different key. There are many using springs, magnets, clamps and tighteners that require 2 hands to manipulate.

While prior devices have their purpose, another issue presented is having good position on the microphone. I have seen Joe Satriani actually duct tape harmonicas to the face of the microphone guaranteeing good placement. This is where the idea for this device came from.

### BRIEF SUMMARY

This device, the Easy Application Harmonica Holder, allows the user to apply it to the microphone quickly and remove it quickly with the use of 1 hand. This device has a groove in the faceplate to slide in place popular raised back-edge diatonic harmonicas. The harmonica simply slides into the groove and out as easy making swapping to a different key quick and easy. The device is 1 piece and has no moving parts.

### DETAILED DESCRIPTION

This one-piece device, the Easy Application Harmonica Holder, allows the user to apply it to the microphone quickly by setting over top of the microphone and remove it quickly by lifting it off, with the use of 1 hand. It is applied over-top of the microphone. It stays in place by using the wrap-around hole at the back of the holder for leverage against the bottom portion of the microphone and the faceplate resting against the front of the microphone. This device has a groove in the faceplate to slide in place popular raised back-edge diatonic harmonicas. The harmonica simply slides into the groove and out as easy making swapping to a different key quick and easy. The device is 1 piece, no moving parts, springs or metal. The back of the faceplate is concaved to mimic a harmonica player cupping the microphone with their hand. It can be made of Epoxy Resin or plastic using a mold.

### DESCRIPTION OF DRAWINGS

FIG. 1—Drawing-Front View-Faceplate (01) Slot where harmonica slides into grooved faceplate. (02) Microphone is behind faceplate; The holder is resting on top of the microphone. (03) A sound hole in faceplate to allow harmonica sound to pass thru to the microphone.

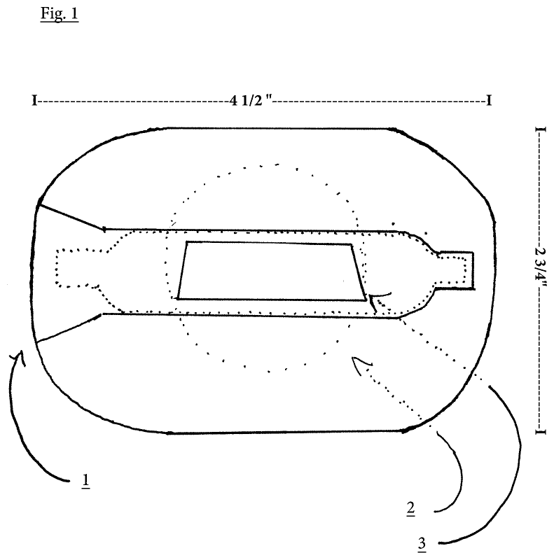

FIG. 2—Drawing-Top/Back View (04) Hole in back of holder used as leverage point to keep holder on the microphone. (05) Cradle area under holder where microphone is. (06) Raised edges on top to strengthen support of holder.

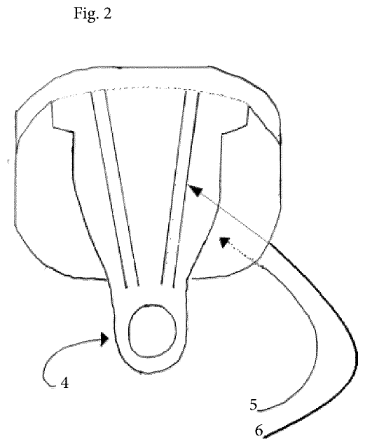

FIG. 3—Drawing-Left Side View (07) Cradle area under holder where microphone is. (08) Back of faceplate is concaved to mimic cupping a microphone. (09) Groove in faceplate where harmonica slides in.

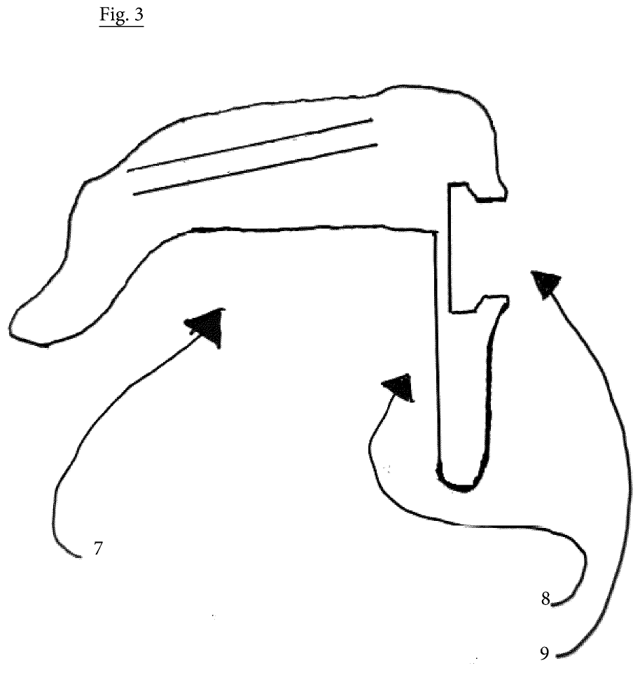

FIG. 4—Drawing-Back Right-side view (10) Harmonica Holder is resting on top of microphone. (11) The Microphone. (12) The microphone holder attached to stand. (13) The microphone stand

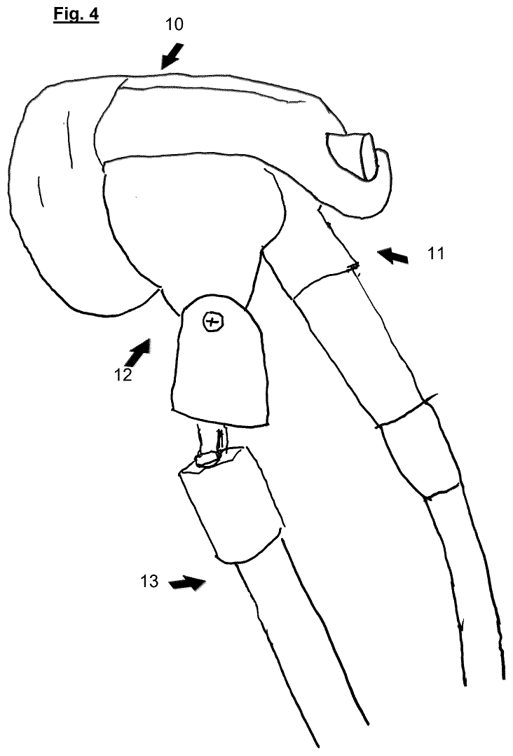

FIG. 5—Drawing-Back Left-side view (14) Harmonica Holder is resting on top of microphone. (15) Harmonica mounted on front inside of slide in groove. (16) The Microphone. (17) The microphone holder attached to stand. (18) The microphone stand.

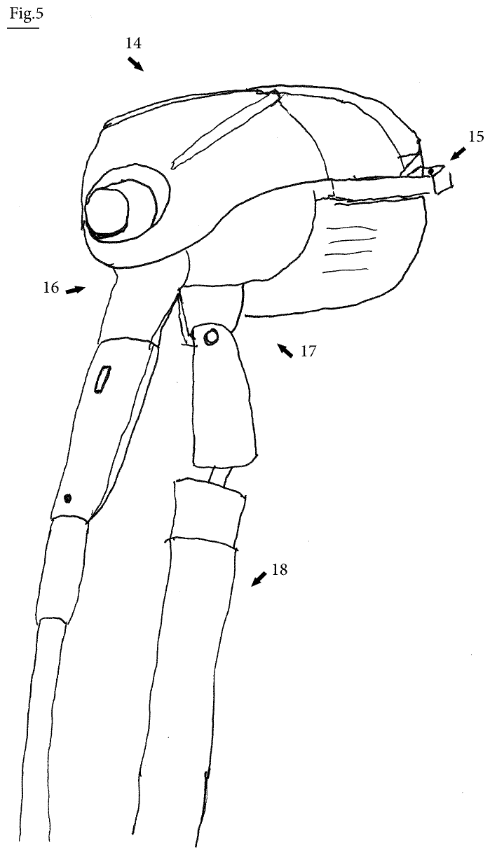

FIG. 6—Image of Trimmed Black and white photo Prototype Front-Left View of Harmonica Holder with harmonica inserted.

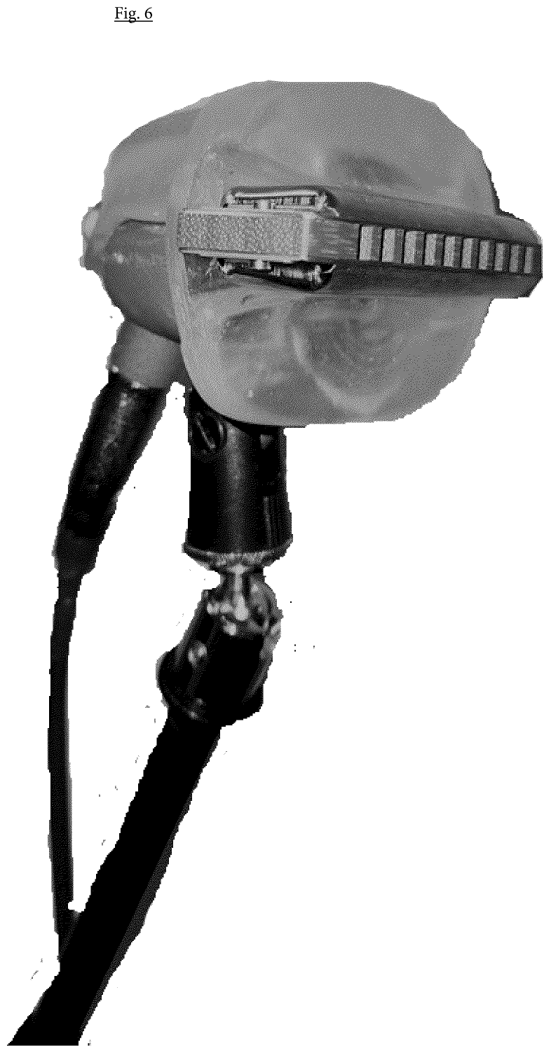

FIG. 7—Image of Trimmed Black and white photo Prototype Front View on microphone with no harmonica in place

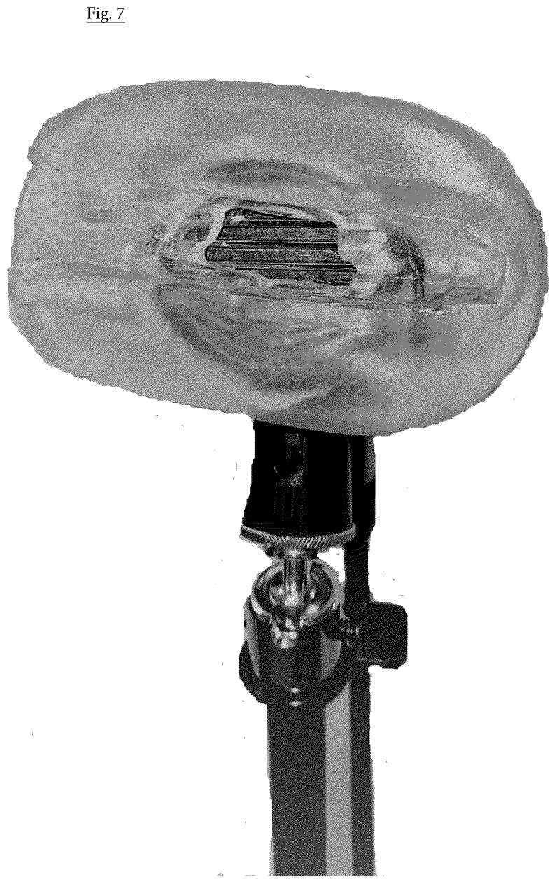

FIG. 8—Image of Trimmed Black and white photo Prototype Front View on microphone with harmonica in place.

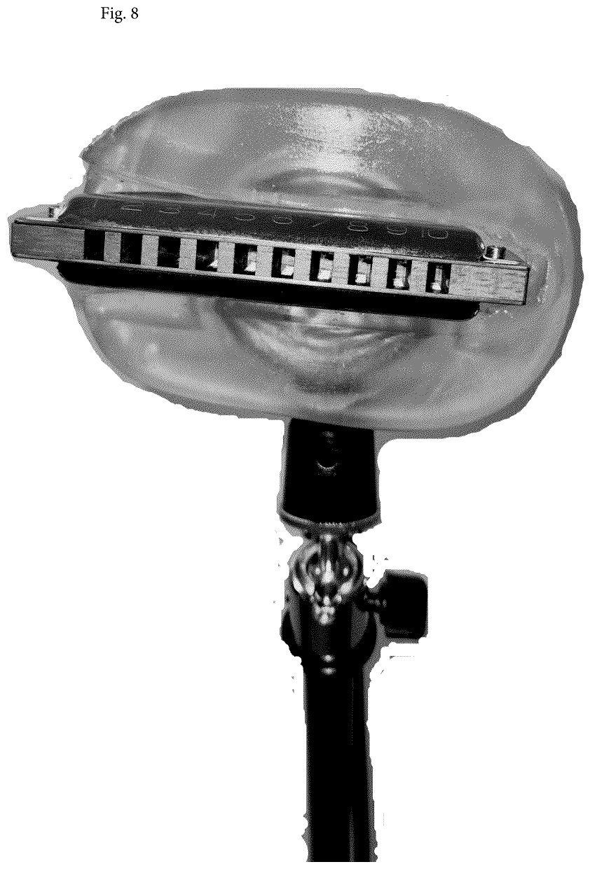

1. The Harmonica holder which comprises 1 solid piece that cradles over top of the microphone while also securing the harmonica to the face of the holder allowing the user to play harmonica hands free and is easily removable by lifting it off of the microphone without complicated methods.
